(19) United States
(12) Patent Application Publication
(10) Pub. No.: US 2011/0198358 A1
(43) Pub. Date: Aug. 18, 2011

(54) ARTICLE WITH A CERAMIC COATING AND METHOD FOR PRODUCING SUCH AN ARTICLE USING A LASER

(75) Inventors: Fabrice Parent, Mery (FR); Laurent Voisin, Sales (FR); Jean-Luc Perillon, Saint Paul Trois Chateaux (FR); Arnaud Hory, Limoges (FR); Quentin Joly, Limoges (FR)

(73) Assignee: SEB SA, Ecully (FR)

(21) Appl. No.: 12/997,574

(22) PCT Filed: Jul. 24, 2009
(86) PCT No.: PCT/FR2009/051504

§ 371 Date: Apr. 4, 2011

(30) Foreign Application Priority Data
Jul. 29, 2008 (FR) 0855221

(51) Int. Cl. A47J 36/02; B32B 15/08; B32B 15/20; B32B 15/18; B32B 15/04; B32B 18/00; B05D 3/06

(52) U.S. Cl. 220/573.1; 428/209; 428/201; 428/64.1; 428/615; 428/685; 428/650; 428/639; 428/626; 428/623; 427/552

(57) ABSTRACT

An article comprising a metal support with two opposing faces at least one of which is covered by a discontinuous ceramic coating. Said coating has a softening point above the melting point of the support and has at least one absorbing element for the laser radiation at a wavelength of the order of 1 μm, being at least 1% of the weight of said coating. The invention further relates to a method for producing said article.

### PRIORITY CLAIM

The present application is a National Phase entry of PCT Application No. PCT/FR2009/051504, filed Jul. 24, 2009, which claims priority from French Application No. 0855221, filed Jul. 29, 2008, the disclosures of which are hereby incorporated by reference herein in their entirety.

### TECHNICAL FIELD

The present invention relates generally to an article comprising a metal substrate comprising two principal faces and at least one ceramic coating covering at least one of these faces, as well as a manufacturing process for such an article in which the ceramic coating is fritted by laser beam.

### BACKGROUND ART

Conventionally, ceramic coatings are applied in the form of an aqueous suspension or slip containing a refractory powder, then fitted by heat treatment (by firing in an oven, for example) during which the grains of refractory powder are fused together by the effect of heat, which results in the consolidation of the coating.

In the particular case of an enamel, sintering is generally achieved by firing during which the fusion of the enamel powder occurs, followed by cooling during which the vitrification of the enamel takes place. With such a sintering process (that is, a process involving firing in an oven), the enamel fit must be applied onto a substrate that is able to withstand the fusion temperature of the enamel (or more precisely its softening temperature).

However, sintering carried out by an oven-firing type thermal route does not allow the creation of a ceramic coating, particularly of the enamel type, on a substrate whose constitutive material has a fusion temperature below the softening point of the ceramic coating, because that would necessarily lead to the melting of the substrate.

In addition, sintering, if carried out in an oven, has the disadvantage of very high energy consumption.

To overcome these disadvantages, the person skilled in the art knows to use a laser to carry out the sintering of a ceramic coating of the vitreous type, such as a glaze or an enamel.

Thus for example, U.S. Pat. No. 3,663,793 describes a process for forming a mark or a design on the surface of an article such as a lamp case made of soda-lime glass. This process comprises a step in which at least part of the surface is coated with a pigmented vitreous frit containing lead oxide in particular and occurring in the form of a slip or aqueous suspension, then an air-drying step to form a powdery layer. Then the case thus coated is subjected simultaneously to the action of a burner flame and that of a laser beam. The burner flame's action allows firing of the powdery layer at a temperature of the order of 700° C., during which it is transformed into a white enamel or glaze type coating.

Given that the flame temperature is very near the softening point of the coating (695° C.) and above the lower refiring temperature (“strain point”) of 470° C. of the soda-lime glass making up the case, the white enamel (or glaze) thus formed constitutes a durable and tough coating which will not fracture when it is subjected to laser radiation. If the burner flame is adjusted to be reducing, the lead oxide in the glaze is transformed into lead under the effect of the laser beam.

In the process of U.S. Pat. No. 3,663,793, the sintering of the powdery layer into white enamel or glaze is accomplished by the effect of a burner flame, the laser beam's role being essentially to reduce the lead oxide to lead so as to form the mark (or the design) on the surface of the glaze.

Further, it is known from Japanese patent application JP 2 279 574 a process for decorating the surface of a wall which may be of brick, of cement, of steel or of aluminium. This process comprises a step in which a vitreous material is flame-sprayed onto the surface of a wall to form there a layer of the vitreous coating, followed by a step in which certain areas of the surface thus coated are irradiated with a laser beam, to form a film of enamel over the vitreous coating.

In the process of JP 2 279 574, the enamel layer on the vitreous coating is in fact made up of the coating previously vitrified during flame spraying, on the surface of which the effect of the laser is manifested by the transformation of certain compounds of the coating, thus creating in the irradiated areas a decorative layer of a superficially different nature from the vitreous coating. Just as before for the process of the U.S. Pat. No. 3,663,793, the laser in the process of JP 2 279 574 is not used to frit the vitreous composition, but only to create the decorative design.

A laser decoration, marking and engraving process for objects with enamelled surfaces is known from French patent application FR 2 575 422. This process comprises a prior step of mixing opacifiers into an enamel which dissociate locally and by optical effect (of the oxides of titanium, of tin, of cerium or of antimony, for example), then a step of optical action on the enamel using a laser beam, for example a CO₂ laser or a YAG laser. As taught in French patent application FR 2 575 422, optical action by the laser route is accomplished either on a previously thermally fired enamel layer, the decoration then being connected with the dissociation of one or more opacifiers on the irradiated portions, or on an enamel layer that is not fired, but which overcoats a layer of enamel made according to customary processes (that is, generally, by oven firing). This French patent application FR 2 575 422 thus does not teach an object having surfaces that are enamelled by the laser route.

International application WO 99/16625 describes a method of marking by thermal activation of a substrate, in particular of stainless steel or of aluminium. This method is based on the laser irradiation of a uniform and continuous layer of a marking material suited to the substrate (particularly of the glass or enamel frit type), this marking material containing a concentrate that absorbs the energy of a laser beam to create a bond to the substrate. In WO 99/16625, the glass or enamel frit occurs in the form of a slip that is oily rather than aqueous, and which therefore has a tendency to spread. It is therefore not possible to form, before sintering, a discontinuous coating. Further, the sintering of such a slip has a tendency to produce soot, the presence of which on the surface of the substrate could interfere with the adhesion of the coating to be formed. Finally, the portion of the marking material that is irradiated by the laser beam is also continuous, which has the consequence that the substrate may not undergo any deformation after irradiation. Further, given that the enamel or glass frit is formulated in the form of an oily slip, there is a consequent coking of the oil during sintering. This coking of the oil, however, consumes a considerable part of the energy delivered by the laser, which is greater than that needed for evaporating water. The energy efficiency of the laser is thereby reduced.

### SUMMARY OF THE INVENTION

The present invention addresses all or part of the above described disadvantages, by forming a discontinuous ceramic or metallic coating fritted by the laser route, occurring in the form of a superficial dispersion of solidified drops of ceramic or metallic material on a substrate, with a lower, even near-zero density in the parts of the substrate that are intended to undergo deformation, particularly of the stamping type. Sintering by the laser route of such a coating makes it possible, on the one hand, to escape the substrate constraint, which can then be constituted of a material with a low melting point, while the coating can be a material with a high melting or softening point; and on the other hand to deposit such a coating without incurring an excessive expenditure of energy.

In that pursuit, embodiments of the present invention propose an article comprising a metal substrate comprising two opposed faces, and a ceramic or metallic coating covering at least one of the faces of the substrate, the ceramic or metallic coating having a softening point that is higher than the melting temperature of the substrate, and comprising at least one component that absorbs laser radiation with a wavelength of the order of 1 μm, constituting at least 1% of the weight of the coating,

wherein the ceramic or metallic coating is a discontinuous layer having a surface roughness Ra of between 2 μm and 10 μm and a thickness of between 5 and 30 μm.

As used herein, the term discontinuous layer means a superficial dispersion of solidified drops of the ceramic or metallic material, these drops having a mean size of between 1 and 40 μm, and being distributed homogeneously on the surface of the coated face, with a coverage of that surface of between 30 and 80%.

As used herein, the term superficial dispersion of solidified drops of ceramic or metallic material means a layer of ceramic or metallic material occurring in a divided state on a substrate (in this case that of a cookware article), such that the roughness of this layer is created by the solidified drops of ceramic or metallic material.

As used herein, the term coverage means the ratio, expressed in percent, of the substrate surface area actually covered by the superficial dispersion of solidified drops to the total substrate area that can be covered.

As used herein, the term ceramic material means any inorganic, essentially non-metallic material.

As used herein, the term non-metallic means that the material has an inorganic lattice in which there may be very small quantities of metallic elements such as aluminium, iron, titanium, lithium, sodium, potassium, calcium.

The following are considered ceramic materials as used herein:
non-metallic inorganic materials other than oxides such as nitrides, borides and carbides (particularly silicon carbide),
non-metallic inorganic materials of the oxide type, such as the oxides of aluminium (Al₂O₃), of titanium (TiO₂), of zirconium, and of silicon,
composite non-metallic inorganic materials, which are composites of the aforementioned oxide type and non-oxide type inorganic materials, and
natural materials such as graphite, the aluminosilicates, the zirconates.

Ceramic materials being refractory materials having heterogeneous compositions and structures, they do not have uniform melting points. For such materials, the refractoriness is generally defined by the softening point.

As used herein, the term softening point or temperature of a refractory material means the temperature at which the material softens or begins to soften and attains a certain consistency under standardized conditions.

As used herein, the term metallic material means any metal or metal alloy capable of absorbing laser radiation at a wavelength of the order of 1 μm.

As metallic materials usable in the present invention to make up the discontinuous layer, stainless steels (food grade, and preferably 304 and 309 stainless steels), titanium and nickel can be mentioned in particular.

To make it possible for the sintering of the ceramic or metallic coating of the article according to the invention to be carried out by laser beam, the coating comprises a component that absorbs the radiation emitted by the laser operating at a given wavelength.

In a general sense, the term absorbing component is taken to mean a substance used to absorb the energy of a given type of radiation.

As used herein, the term component absorbing laser radiation at a given wavelength means a substance used to absorb the energy of laser radiation emitted by a laser emitting at that wavelength.

Within the scope of embodiments of the present invention, a laser operating at a wavelength of the order of 1 μm can be used to advantage, as for example a line laser emitting a wavelength of 980 nm, or a fiber laser emitting at a wavelength of 1,064 nm.

As components that can absorb laser radiation at a wavelength of the order of 1 μm and are capable of being used in the layer of the present invention, an absorbing component selected from among the stainless steels (preferably those approved within the scope of food preparation use), the metal oxides, particularly among the oxides of aluminium (Al₂O₃), of titanium (TiO₂), the iron oxides, the mixed oxides of copper, iron and manganese, silicon carbide, tungsten carbide and graphite.

Thus, in the case of a metallic coating as that term is used in the present invention, it is by nature made up of a material that absorbs laser radiation at a wavelength of the order of 1 μm, and it is therefore not necessary to add an additional component that absorbs laser radiation to the aqueous metal powder suspension that is applied to the support for the purpose of forming the coating.

The same is true in the case of a ceramic coating made up for example of alumina or titania which are also materials that absorb laser radiation at a wavelength of 1 μm.

On the other hand, if the coating is made of an inorganic material obtained by fusing an enamel frit for instance, it is necessary to add at least 1% by weight, referred to the weight of the fit, of at least one component that absorbs laser radiation at a wavelength of the order of 1 μm to the aqueous suspension of enamel frit (or slip) that is applied to the substrate. In fact, even if an enamel frit comprises alumina in its composition (which is that obtained after transition to the molten state), it no longer absorbs laser radiation. In fact, the aluminium that enters into the composition of the enamel fit is no longer in the form Al₂O₃: it is included in an inorganic lattice, that is to say connected to other elements besides aluminium (Al) and oxygen (O).

As components that absorb laser radiation at a wavelength of the order of 1 μm, it is also possible to use within the scope of the present invention organic dyes (organic absorbers, as for example the organic borate dyes developed by the Exciton company) or mineral pigments such as the oxides of cobalt, of chromium, and in particular mineral pigments based on CoCrFeNi, ZrSiCoNi, CoAl.

According to one particularly advantageous embodiment of the present invention, the ceramic coating is a coating that comprises enamel, whose composition is suited to the nature of the substrate, in particular an “aluminium enamel,” a “glass enamel,” a “sheet steel enamel” (preferably stainless steel) or a “ceramics enamel”.

As used herein, the term “aluminium enamel” means an enamel with a low softening point (below 600° C.).

As used herein, the term “glass enamel” means an enamel with a softening point between 600 and 650° C.

As used herein, the term “sheet steel enamel” (preferably stainless) means an enamel with a softening point near 800° C.

As used herein, the term “ceramics enamel” means an enamel with a very high softening point (higher than 900° C. in particular).

Whatever the nature of the enamel covering the substrate, it must be matched to the substrate in terms of thermal coefficient.

Of course, the parameters of the laser (wavelength and power in particular) must be suited to the nature of the enamel used. For example, the power of the laser beam, the laser beam's scan rate, the impulse time, the frame period are parameters to be adjusted to match the enamel and the quantity of radiation-absorbing components present in the composition of the enamel; less energy is required for enamels with low fusion points than for enamels with high fusion points.

As examples of (laser power/scan rate) pairs allowing sintering to be carried out, (4 to 5 kW, 10 to 15 m/s), (200 W, 2 m/s) and (50 W, 400 to 500 m/s) are recommended.

According to a first variation of this embodiment, the substrate is made of aluminium or aluminium alloy. For such a variant embodiment, it is possible to use a “sheet steel enamel” whose composition typically contains:
SiO₂: >55%
BaO₃: approx. 10%
Na₂O: approx. 10%
Li₂O: <5%,
Oxides of barium, cobalt, nickel, copper, titanium, manganese: <3% for each compound, the percentages given being percentages by mass.

Sintering by the laser route of such a coating comprising enamel results in a vitrified enamel containing less than 20% of fluxing component(s), while sintering by a more conventional route such as oven firing leads to a much higher flux content, of the order of 35%.

As used herein, the term fluxing component means any substance present within the enamel composition which, even in minimal quantity, lowers the softening point of the ceramic material.

As fluxes usable in a ceramic coating according to embodiments of the invention, alkalis and alkaline earths, or more particularly sodium oxide, potassium oxide, boron oxide, bismuth oxide and vanadium oxide are recommended.

As aluminium alloys suited for use in making the substrate of the article according to embodiments of the invention, enamellable low-alloy aluminium alloys and aluminium casting alloys are recommended.

Particularly recommended, as suitable enamellable low-alloy aluminium alloys, are:
“pure” aluminiums with 99% aluminium in the 1000 series, as for example the 1050, 1100, 1200 and 1350 alloys,
aluminium-manganese alloys in the 3000 series, as for example the 3003, 3004, 3105 and 3005 alloys,
aluminium-silicon alloys in the 4000 series, as for example the 4006 and 4007 alloys,
aluminium-magnesium alloys in the 5000 series, as for example the 5005, 5050 and 5052, and 5754 alloys,
aluminium-silicon-magnesium alloys in the 6000 series, as for example the 6053, 6060, 6063, 6101 and 6951 alloys, and
aluminium-iron-silicon alloys in the 8000 series, as for example the 8128 alloy.

As aluminium casting alloys suitable for use in making the substrate of the article according to embodiments of the invention, it is possible to use any kind of aluminium-silicon AS alloy, and particularly the aluminium-silicon alloys which are customarily produced in connection with enamelling because they have a fusion temperature close to or even below the softening point of the enamels. More particularly recommended are the AS7 to AS12 type aluminium-silicon AS alloys, that is AS alloys containing from 7 to 12% silicon in accordance with former French standard NF AS 02-004.

According to a second variation of this embodiment of the present invention, in which the ceramic coating is a coating comprising enamel, the substrate is made of stainless steel. For such an embodiment, the enamel coating can be a conventional enamel such as a “sheet steel enamel,” preferably stainless, with the weighbatching composition:

SiO₂: >55%,

B₂O₃: approx. 10%,

Na₂O: approx. 10%,

Li₂O: <5%,

Oxides of barium, cobalt, nickel, copper, titanium, manganese: <3% for each compound.

It is also possible to use either a “stainless enamel,” but it is possible to use a “ceramics enamel” with the composition:

SiO₂: >65%

B₂O₃: >10%

Na₂O: <10%

K₂O: <10%

ZrO₂: <5%

the percentages given being percentages by mass.

Within the scope of this embodiment of the present invention where the ceramic coating is an enamel coating, the article may also comprise, besides the enamel coating covering at least one of the principal faces of the substrate, a non-stick coating including at least one layer including at least one fluorocarbon resin, alone or mixed with a thermally stable bonding resin tolerating at least 200° C., this bonding resin forming a continuous fritted lattice after sintering.

As fluorocarbon resins usable in the non-stick coating according to the invention, polytetrafluoroethylene (PTFE), tetrafluoroethylene-perfluoropropylvinylether copolymer, tetrafluoroethylene-hexafluoropropylene copolymer (FEP), and their mixtures (particularly a mixture of PTFE and PFA) are recommended.

As bonding resins usable in the non-stick coating according to the invention, the polyamide-imides (PAI), the polyetherimides (PEI), the polyimides (PI), the polyetherketones (PEK), the polyether-etherketones (PEEK), the polyethersulfones (PES) and the polyphenylene sulfides (PPS) and their combinations are recommended.

The non-stick coating covering the hard enamel base can comprise a layer of bonding primer and at least one finish layer, at least one of the finish layers defining a surface layer, the primer layer and the finish layer(s) each comprising at least one fritted fluorocarbon resin, alone or in admixture with a thermally stable bonding resin tolerating at least 200° C., which form(s) a continuous fritted lattice of fluorocarbon resin, and of bonding resin if applicable.

The primer layer can also comprise mineral or organic fillers and/or pigments.

As fillers usable in the primer composition of the article according to the invention, colloidal silica, mica flakes coated with TiO₂, alumina, corundum, quartz and their mixtures can be mentioned in particular.

The non-stick coating can comprise, particularly in the primer, a component that absorbs laser radiation at a wavelength of 10.6 μm.

As examples of components absorbing laser radiation at a wavelength of 10.6 μm, metal oxides, particularly iron oxides, are recommended.

As the non-stick coating is created on the enamel-containing ceramic coating, however, the sintering of such a coating can be advantageously carried out by the laser route even if this coating does not comprise a component that absorbs laser radiation at a wavelength of 10.6 μm.

In such a configuration, the laser beam passes through the non-stick coating and is absorbed by the underlying ceramic coating, which heats it by thermal conduction.

In fact, in such a configuration, it is advantageous that the non-stick coating comprise fillers facilitating thermal conduction within the non-stick coating, and more particularly through the bonding primer. Generally, it is less desirable to introduce these fillers into the surface layer because they would tend to lessen the non-stick characteristic of the coating.

Different types of articles conforming to embodiments of the invention can be contemplated. For example, in the cookware field, flat discs intended to be stamped into the final shape of a cookware article, or cookware articles as such, whether or not they are intended for cooking food, can be contemplated, in which a first of the two opposed faces is a concave inner face intended to be placed next to the food to be placed in the article, and a second of the two opposed faces is a convex outer face intended to be placed next to a heat source.

For the purpose of the present invention, the term flat disc means a solid round metal part, commercially flat, cut from a sheet or a strip.

It is also possible to use other types of flat substrate whose shapes are suited to the cookware article that one wishes to make (particularly in elliptical, rectangular or square shapes).

As non-limiting examples of cookware articles conforming to the present invention, cookware articles such as pots and pans, woks and frying pans, crepe makers, grills, moulds and plates for pastry-making, barbecue grills and griddles are particularly mentioned.

Other substrates can also be contemplated that are not limited to the cookware field. Thus, one can also contemplate domestic electrical appliances, or even plastic components for automobiles or for bottle manufacture, as articles conforming to the invention.

Embodiments of the invention include a method and an article made from a method having the following successive steps:
a step in which a metal substrate comprising two opposed faces is supplied, then
a step in which a ceramic or metallic composition is applied to at least one of the faces of the substrate to form an unfritted layer, the ceramic or metallic composition comprising a ceramic or metallic powder and at least one component that absorbs laser radiation at a wavelength of the order of 1 μm, which makes up at least 1% of the weight of the powder,
a laser beam sintering step at a wavelength of the order of 1 μm and irradiating at least partially the discontinuous layer,

wherein the process sintering includes:
the ceramic or metallic composition being an aqueous dispersion, and
at least one of the aqueous composition application or non-fitted layer sintering steps being carried out so as to form a discontinuous ceramic or metallic layer.

Preferably, the ceramic or metal powder is present in the ceramic or metallic composition at the rate of 45% to 75% by weight of the total weight of said composition.

Such a process has the advantage of sharply limiting the energy consumption that is usually needed for sintering a ceramic coating, particularly of the enamel type, by reducing it by a factor of 100 with respect to sintering by a thermal route.

Furthermore, with such a process, it is possible to carry out the sintering of the ceramic coating on a substrate that does not necessarily have the final shape of the article, a flat substrate for example, such as a disc, which is intended to be stamped to give it the final shape of the article: each drop of ceramic or metallic material is integral with sufficiently strong adhesion to the substrate to allow it to undergo slight deformations without detaching the discontinuous layer from it.

According to an embodiment of the process of the invention, the ceramic or metallic composition sintering step is carried out by a laser beam irradiating in a continuous scan (in the form of lines with a definite thickness and interval between lines) at least a part of the face coated with the ceramic composition.

According to an embodiment of the process of the invention, the ceramic composition sintering step is carried out by a laser beam irradiating in a discontinuous scan (in the form of spots having a definite diameter and interval) at least a part of the face coated with the ceramic composition.

Other advantages and features of the present invention will arise from the description that follows, given as a non-limiting example and made with reference to the annexed figures.

### BRIEF DESCRIPTION OF THE DRAWINGS

FIG. 1 is a schematic section view of a cookware article conforming to the invention according to a first embodiment;

FIG. 2 is a schematic section view of a cookware article conforming to the invention according to a second embodiment; and

FIG. 3 is a schematic section view of a cookware article conforming to the invention according to a third embodiment.

### DETAILED DESCRIPTION OF THE DRAWINGS

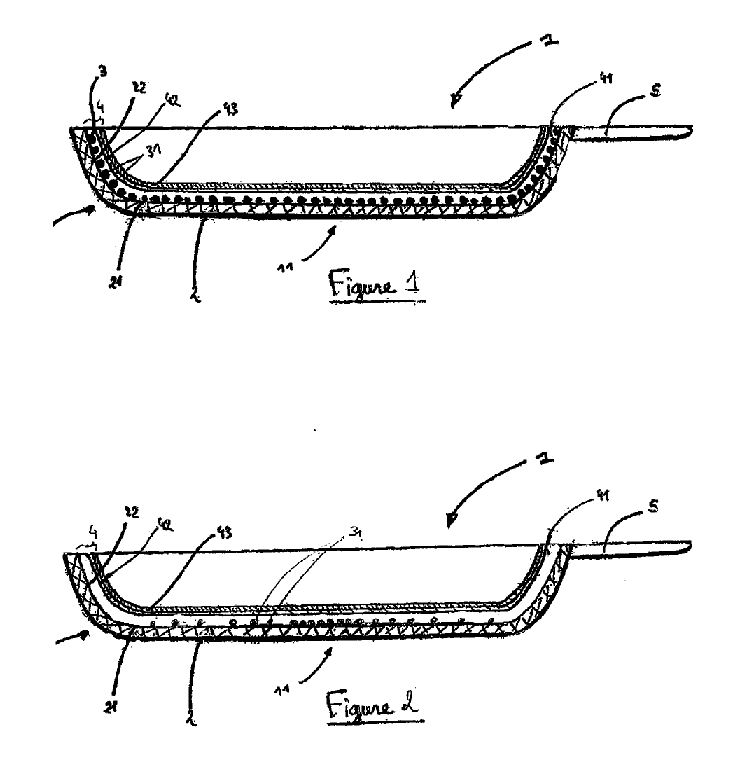

Identical components shown on FIGS. 1 to 3 are identified by identical reference numbers.

In FIGS. 1 to 3 depict, by way of example of a cookware article according to embodiments of the invention, a pan 1 comprising a metal substrate 2 occurring in the form of a hollow shell provided with a handle 5, the shell comprising a bottom 1 and a side wall rising from bottom 1. Substrate 2 comprises an inner face 21 which is the face oriented toward the food to be accommodated in pan 1, and an outer face 22 which is intended to be arranged toward an outside heat source.

Inner face 21 is successively coated, beginning at substrate 2, with a ceramic or metallic coating 3 and with a non-stick coating 4 which comprises successively, beginning at the hard base 3, a bonding primer layer 41 and two finish layers 42, 43. Coating 3 thus constitutes a hard base for the non-stick coating 4 that covers it.

The ceramic or metallic coating 3 covering inner face 21 of substrate 2 is a discontinuous layer, having a surface roughness Ra of between 2 μm and 10 μm and a thickness of between 5 and 30 μm, preferably between 5 μm and 15 μm. This discontinuous layer 3 is in fact made up of a superficial dispersion of drops of ceramic or metallic material which are solidified and have a mean size of between 1 μm and 40 μm.

In a first variation of a cookware article according to an embodiment of the invention illustrated in FIG. 1, the solidified drops are homogeneously distributed over the entire surface of inner face 21, with an inner face 21 coverage of between 30 and 80%.

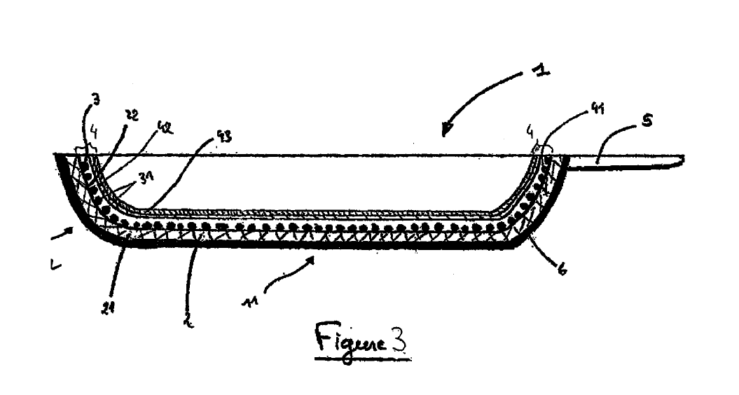

In a second variation of a cookware article according to an embodiment of the invention shown in FIG. 2, the superficial dispersion of solidified drops 31, covering inner face 21 of substrate 2 to make up the ceramic coating 3, is not uniform. In this variation, the enamel drop density is maximal in the central part of the bottom 12 of pan 1, and decreases toward the side wall 11.

A third variation of a cookware article according to an embodiment of the invention also has a superficial dispersion of drops of ceramic or metallic material 31, which are solidified and cover the inner face 21 of substrate 2. This dispersion is also not uniform. In this variant, the density of solidified drops 31 is nil in the joining zone 13 between the bottom 11 and the side wall 12 of the pan (which corresponds to the part of the article during forming, particularly by stamping), and the density of solidified drops 31 is maximal in the central part of bottom 12 and the side wall, which are the parts of the pan that undergo no deformation during forming, particularly by stamping.

In the embodiment variations shown in FIGS. 1 to 3, the drops of ceramic or metallic material 31, which are dispersed on the surface of inner face 2, are embedded in the primer layer 41 of non-stick coating 4, so as to allow bonding of the primer layer, so that increased mechanical reinforcement of non-stick coating 4 is obtained, particularly in terms of hardness and adhesion to the underlying hard base 3. The particles of fitted fluorocarbon resin and the fillers in primer layer 41, by penetrating between the solidified drops 31 of ceramic or metallic material deposited on the surface of inner face 21, strengthen the adhesion of the primer layer 41 to hard base 3. As a result, the mechanical reinforcement of non-stick coating 4 is increased both because of the fillers in primer layer 41 and because of the dispersion of solidified drops 31 of hard base 3 which play a role similar to that of a reinforcing filler in the interpenetration zone of the two layers 3, 41.

Further, FIG. 3 shows that the outside face 22 of substrate 2 can be advantageously coated with an outside enamel coating 6. The thickness of this outside (or cover) enamel coating 6 is conventionally between 40 μm and 500 μm, particularly between 40 μm and 100 μm for an aluminium alloy substrate (low alloy or aluminium casting), between 200 μm and 500 μm for a cast iron substrate (meaning an alloy of iron and carbon with more than 21% carbon) and lastly between 100 μm and 200 μm for a stainless steel substrate.

The metal shell 2 used as a substrate is advantageously made of aluminium or aluminium alloy, as an aluminium casting (or of an aluminium casting alloy), of stainless steel, of cast iron (an alloy in the sense of the term's sign, to wit, an alloy with more than 21% carbon), or of copper.

Two embodiments are given hereafter of a manufacturing process for a cookware article 1 conforming to the invention according to the first embodiment variation, which comprise each of the following steps:
a step in which a metal substrate 2 is supplied comprising two opposed faces 21, 22;
a step of applying to at least one of the opposed faces 21 a ceramic or metallic composition 3a in the form of an aqueous dispersion of a ceramic or metal powder; and
a step of sintering the ceramic or metallic composition 3a to form the hard base 3.

In the first embodiment of the process of the invention, substrate 2 has the final shape of a cookware article, with a concave inner face 21 intended to be set next to the food to be put the said article 1, and a convex outer face 22 intended to be set next to a heat source. In other words, the forming of the article is carried out before the deposition of any coating, whether internal or external.

In the second embodiment of the process of the invention, the step of forming substrate 2 is carried out after the step of creating non-stick coating 4 on internal discontinuous hard base 3. A flat substrate is therefore employed, a disc for example, which will be stamped after the sintering step.

For both embodiments, the step of applying the ceramic or metallic composition 3a to at least one of the faces 21 of the substrate is preceded by a surface preparation step.

Advantageously, the application of the ceramic or metallic composition 3a to inner face 21 is preceded by a surface preparation step which may vary according to the nature of the substrate:
acid degreasing for a steel substrate;
fine sandblasting for a stainless steel substrate;
degreasing, followed or not by matt etching, brushing or sandblasting for an aluminium alloy substrate, and bead-blasting for a cast iron substrate.

For both embodiments of the process of the invention, aqueous composition 3a comprises from 45% to 75% by weight of a ceramic or metallic powder, with at least one component absorbing laser radiation at a wavelength of the order of 1 μm, which makes up at least 1% referred to the total weight of the powder.

As a ceramic or metallic composition (3a) usable in the process of the invention, it is possible to use an aqueous slip of enamel fit, or an aqueous suspension of alumina, or of titanium dioxide, or even an aqueous suspension of stainless steel powder (preferably food grade), or a mixture of these various compounds.

For both embodiments of the process of the invention, the sintering step is carried out by laser radiation irradiating at least partially face(s) 21, 22 coated with refractory composition 3a, at a wavelength of the order of 1 μm. The laser beam contributes the energy needed for sintering the irradiated portions coated with the refractory composition 3a and creating the ceramic coating 3.

For sintering by the laser route, either a fiber laser of the YAG type operating at a power level of 50 Watts and emitting at a wavelength of 1,064 nm can be used, or a line laser operating at a power level of the order of 350 Watts and emitting at a wavelength of 980 nm. The power of the laser (fiber or line) must be matched to the production rate, and could possibly exceed 50 W or 350 W.

According to a first alternative to embodiments of the process of the invention, the ceramic or metallic composition 3a is applied so as to form a continuous non-sintered layer 3 and the sintering step is carried out by a laser beam irradiating in a discontinuous scan this non-fitted layer 3.

According to a second alternative to the process of embodiments of the invention, the ceramic or metallic composition 3a is applied so as to form a discontinuous non-fritted layer 3 and the sintering step is carried out by a laser beam irradiating in a discontinuous and/or continuous scan this non-fritted layer 3.

Discontinuous scanning can for example be carried out by a 4,000 W fiber laser with an 800 □m spot, which automatically scans out a predefined grid representing a number of pixels (in dpi, or number of laser impact points) on the surface of the discs. This makes it possible to leave unfitted the parts that will be deformed during the forming of the substrate (particularly by stamping).

In the case of discontinuous scanning by the laser beam, this is generally followed by a step in which non-fritted particles (those not adhering to the substrate) are eliminated, which can be carried out by blowing, brushing, water jets, air jets, an immersion bath, by scanning, by vibrations or by ultrasound.

For both of the above described embodiments of the process of the invention, the aqueous suspension dispersion of ceramic or metallic powder can be applied to the inner face 21 of substrate 2 by pneumatic spraying under a spraying pressure greater than or equal to 4 bars, and the quantity of enamel deposited onto said inner face 21 is between 0.1 g/dm² and 3 g/dm².

For both of the above described embodiments of the process of the invention, the non-stick coating 4 on enamel layer 3 is carried out by depositing at least one layer of fluorocarbon resin-based composition 4a, then a sintering step to form a non-stick coating 4 occurring in the form of a continuous fritted lattice of fluorocarbon resin, regardless of the nature of the ceramic (particularly an aqueous suspension of alumina or titanium dioxide or an aqueous enamel fit slip) or metallic (particularly an aqueous suspension of stainless steel powder) composition.

The sintering of non-stick coating 4 can be carried out either thermally in an oven, at a temperature of between 370° C. and 430° C., or with a CO₂ laser whose wavelength is 10.6 μm. This wavelength allows a more homogeneous heat treatment to be obtained.

### EXAMPLES

Products

Lasers
Fiber laser operating at a power level of 4 kW and emitting at a wavelength of 1064 nm (Examples 1, 6):
   Source: Nd YAG
   Scan rate: between 10 and 15 m/s
   Spot diameter: between 800 and 1,200 μm
Fiber laser operating at a power level of 5 kW and emitting at a wavelength of 1,064 nm (Examples 2, 7)
   Source: Nd YAG
   Scan rate: between 10 and 15 m/s
   Spot diameter: between 800 and 1,200 μm
Fiber laser operating at a power level of 50 W and emitting at a wavelength of 1,064 nm (Examples 2, 3, 5)
   Source: Ytterbium
   Scan rate: between 200 and 800 mm/s
   Vectoring: between 10 and 100 μm
   Spot diameter: between 100 μm

Substrates
discs of 8128 aluminium 300 mm in diameter (Examples 1, 2, 6 and 7) to be stamped to form the shell of a cookware article,
square plates of 4917 aluminium, each side being 100 mm (Examples 3 through 5)

Coating compositions: these are aqueous suspensions of enamel fit or of alumina, titanium dioxide or steel powder, whose characteristics are given below:

Frit F1 of “aluminium enamel” with weighbatching composition:

Al₂O₃: less than 1%;

B₂O₃: less than 1%;

BaO: less than 1%;

Frit FC1 of “aluminium enamel” with weighbatching composition:

Al₂O₃: less than 1%;

B₂O₃: less than 1%;

BaO: less than 1%;

K₂O: 12%;

Li₂O: less than 4%;

Na₂O: 18%;

P₂O₅: less than 4%;

SiO₂: 35%;

TiO₂: 22%;

V₂O₅: less than 10%.

Frit F2 of “sheet steel enamel” with weighbatching composition:

SiO₂: >55%,

B₂O₃: approx. 10%,

Na₂O: approx. 10%,

Li₂O: <5%,

Oxides of barium, cobalt, nickel, copper, titanium, manganese: <3% for each compound.

Alumina powder with grain-size distribution d50<10 □m,

Titanium dioxide powder with grain-size distribution d50<5 □m,

304 stainless steel powder with grain-size distribution d50<10 □m.

The percentages given are all percentages by mass.

Absorbers

Iron (III) oxide (Fe₂O₃) or iron (II) oxide (FeO)

Tests

Evaluation of Abrasion Resistance

The abrasion resistance of the non-stick coating formed is evaluated by subjecting it to the action of a green SCOTCH BRITE© type abrasive pad.

The coating's abrasion resistance is quantitatively estimated by the number of passes with the pad needed to create the first scratch (exposing the metal of which the substrate is made).

Evaluation of Non-Stick Characteristic

The non-stick characteristic is measured according to the greater or lesser ease of cleaning off charred milk. The rating scheme is as follows:

100: means that the charred milk film is completely eliminated by applying only a stream of water from the kitchen faucet;

50: means that circular motion of the object under the water stream must be added to completely detach the charred film;

25: means that a 10-minute soak is needed and it may be necessary to force removal by running a wet sponge to completely remove the film;

0: means that upon completion of the foregoing process, all or part of the charred film remains attached.

Evaluation of Adhesion of the Sintered (or Fitted) Coating to the Substrate

The adhesion of the fritted (or sintered) ceramic or metallic coating to the substrate is also evaluated. For this purpose, a checkerboard test is done per ISO 2409 standard, followed by immersion of the article for 9 hours (three cycles of three hours in boiling water). Then the non-stick coating is inspected to see whether or not it shows detachment.

The rating scheme is as follows:

to obtain a rating of 100, no square may be detached (excellent adhesion);

if detachment occurs, the value assigned is 100 minus the number of detached squares.

Evaluation of Impact Resistance of the Fitted Coating

To evaluate impact resistance of the fritted coating, the procedure is as follows: the plate is subjected to the action of a hemispherical punch 20 mm in diameter, weighing 2 kg and falling 50 cm onto the back face. The coated face is inspected.

Then, an adhesive tape is firmly applied to the impacted part, then sharply pulled off, and the tape is examined under the optical microscope. The absence of dust indicates excellent adhesion of the hard base to the substrate.

Generally, for cookware applications it is the inner face in contact with the food which must be processed according to the process of the invention.

In the examples, a coating composition according to the process of an embodiment of the invention is applied to one of the faces of the substrates. After the substrate is turned over, the second face can either be processed the same way (that is by sintering by the laser route) or processed in the traditional manner (that is by firing in an oven at a temperature of the order of 560° C.).

### Example 1

Starting with an Aqueous Slip Based on “Aluminium” Enamel Frit with an Absorber, and Sintering by the Laser Route

Procedure
1. An aluminium disc 300 mm in diameter is used as the substrate. This disc is degreased, then brushed to obtain a roughness Ra of 1.5 μm.
2. An aqueous slip of enamel fit is prepared from “aluminium” enamel fit F1 according to the proportions given below:
100 parts frit by weight
60 parts water by weight
1 part absorber by weight
3. Then this slip is applied to one of the faces of the substrate by pneumatic spraying under a pressure of 5 bars: the deposit obtained is discontinuous and the dry weight deposited is 1.2 g before sintering.
4. For laser sintering of the enamelled deposit, a fiber laser is used operating at 4 kW and emitting at a wavelength of 1,064 nm: the laser beam scans the entire surface and frits the enamel droplets to form a discontinuous enamel layer.
5. The excess, non-fritted enamel is eliminated by brushing and blowing. The disc is not noticeably heated, because it can still be handled with bare hands.
6. Then a layer of primer and a PTFE-based finish layer are applied in succession to each of the faces. The application of these PTFE-based non-stick layers can be accomplished by silkscreening or by pneumatic spraying (or by roller).
7. The sintering of these non-stick layers is carried out by oven firing at 415° C. for 7 minutes.
8. Finally, the disc thus prepared is stamped to form the shell of a pan conforming to the present invention, such that the inner face is that which includes a hard base under the non-stick coating.

It is noted that the inner coating (on the inner face) shows no visible fissures.

Evaluation of Abrasion Resistance

Results of the abrasion resistance test show that after 20,000 “round trip” passages of an abrasive pad, the coating shows no scratches exposing the metal.

Evaluation of Fitted Coating Adhesion to the Substrate

The adhesion measured by the checkerboard test after immersion is excellent: there are no detached squares.

Evaluation of the Non-Stick Characteristic (So-Called “Burnt Milk” Test)

The non-stick characteristic evaluated by the burnt milk test gives a score of 50.

### Control Example C1.1

Starting with an Aqueous Slip Based on “Aluminium” Enamel Frit with No Absorber and Sintering by the Laser Route

Procedure
1. An aluminium disc 300 mm in diameter is used as a substrate. This disc is degreased, then brushed to obtain a roughness Ra of 1.5 μm.
2. An aqueous slip of enamel fit is prepared from the FC1 “aluminium” enamel frit using the proportions given below:
100 parts by weight of frit, and
60 parts by weight of water.
3. Then this slip is applied to one of the faces of the substrate by pneumatic spraying under 5 bars pressure: the deposit obtained is discontinuous and the dry weight deposited is 1.2 g before sintering.
4. For laser sintering of the enamelled deposit, a fiber laser is used, operating at 4 kW and emitting at a wavelength of 1,064 nm: the laser beam scans the entire surface.

As the fit does not absorb the radiation, no heating of the material is noted; the hard base remains in the form of a powder deposit not adhering to the metal substrate.

The absence of a specific absorber component prevents the creation of the hard base. It is further noted that TiO₂, though present in the fit in the amount of 22%, does not confer upon it absorbing properties with respect to the laser beam.

### Control Example C1.2

Starting with an Aqueous Slip Based on “Aluminium” Enamel Frit and Sintering by Oven Firing at 560° C.

Procedure:
1. An aluminium disc 300 mm in diameter is used as a substrate. This disc is degreased, then brushed to obtain a roughness Ra of 1.5 μm.
2. An aqueous enamel frit slip is prepared from F1 “aluminium” enamel frit using the proportions given below:
   100 parts by weight of frit,
   60 parts by weight of water, and
   1 part by eight of an absorber.
3. Then this slip is applied to one of the faces of the substrate by pneumatic spraying under 5 bars pressure: the deposit obtained is discontinuous and the dry weight deposited before sintering is between 0.6 and 0.8 g.
4. The discontinuous layer is fired in an oven at 560° C. for 8 minutes to harden it.
5. Then a layer of primer and a PTFE-based finish layer are applied successively to each face of the substrate. The application of these PTFE-based non-stick layers can be carried out by silkscreening or by pneumatic spraying (or by roller).
6. The sintering of these non-stick layers is carried out by oven firing at 415° C. for 7 minutes.
7. Finally, the disc thus prepared is stamped to form the shell of a pan conforming to the present invention, in such a way that the inner face is the one that has a hard base under the non-stick coating.

The interior coating (inner face) does not show any visible fissures.

Evaluation of Abrasion Resistance

The test results show that the first scratch (exposing the metal constituting the substrate) is visually observed (under 8× optical magnification) only after 20,000 passes with the pad.

Evaluation of Substrate Adhesion of the Fitted Coating

Adhesion measured by the checkerboard test after immersion is excellent: no squares are torn off.

Evaluation of the Non-Stick Characteristic (So-Called “Burnt Milk” Test)

The non-stick characteristic evaluated by the burnt milk test gives a grade of 100.

Test results are comparable to those obtained in Example 1, but with a much higher energy consumption.

Energy consumption ΔQ₂ was compared to ΔQ₁, that of sintering by the laser route, based on formula (1):

ΔQᵢ=mᵢ*Cpᵢ*ΔTᵢ
Where:
i designates the material as follows:
i=1 to designate the aluminium disc,
i=2 to designate the discontinuous enamel layer
Cpᵢ designates the specific heat of material i,
ΔTᵢ designates the temperature variation undergone by material i, and
mᵢ designates the mass of the material.
Sintering by oven firing at 560° C. of the enamelled disc results in an energy consumption ΔQᵢ of 194,400 J, considering that:
given its dimensions, the disc weighs approximately 400 g (m₁),
the temperature variation ΔT₁ undergone by the aluminium substrate is 560° C.-20° C. (ambient temperature), that is a temperature variation of 540K,
the specific heat Cp₁ of aluminium is 900 J/kg*K.

For calculating the energy consumption ΔQ₁ in oven firing, we have not taken the enamel layer into account, because the energy consumption for firing 1.2 g of enamel at 560° C. is negligible compared with that needed to raise the temperature of a 400 g disc made of aluminium from 20° C. to 560° C. Further, this calculation does not take into account the set of losses connected with the use of the stove (the stove itself, air, conveyors).

The estimation of the energy consumption ΔQ₂ of sintering by the laser route was therefore carried out considering that:

only the hard base (m₂=1.2 g) is heated, and not the entire disc,

the temperature variation ΔT₂ that the enamel frit undergoes is 2,500° C.−20° C. (ambient temperature), that is a temperature variation of 2,420K,

the specific heat Cp₂ of the frit is 800 J/kg*K.

The energy consumption ΔQ₂ of sintering by the laser route is only 2,381 J, that is an energy consumption reduction of more than 98% (98.7% exactly) compared to oven firing at 560° C.

The energy consumption ratio ΔQ₁/ΔQ₂ is 1.22%, which corresponds to a reduction of energy consumption of 98.7% when switching from oven firing at 560° C. to sintering by the laser route under the experimental conditions given earlier.

Besides the approximations stated above, the calculation is also approximate in that the temperature attained by the frit under the effect of the laser has been overestimated.

Furthermore, the laser's efficiency is of the order of 66% and the residual heating of the disc is slight (a few degrees), even with a continuous scan.

The applicant has considered, however, that taking into account all the above considerations would not appreciably change the energy ratio favoring the laser.

### Example 2

Starting with an Aqueous Slip of “Steel Enamel Frit” with an Absorber and Sintering by the Laser Route

Procedure
1. An aluminium disc 300 mm in diameter is used as a substrate. This disc is degreased, then brushed to obtain a roughness Ra of 1.5 μm.
2. An aqueous enamel frit slip prepared from F2 “steel” enamel frit using the proportions shown below:
100 parts by weight of frit
60 parts by weight of water, and
1 part by weight of absorber.
3. Then this slip is applied to one of the faces of the substrate by pneumatic spraying under 5 bars pressure: the deposit obtained is discontinuous and the dry weight deposited is 1.2 g before sintering.
4. For laser sintering the enamelled deposit a fiber laser is used, operating at 5 kW and emitting at a wavelength of 1,064 nm: the laser beam scans the entire surface and fits the droplets of enamel to form a discontinuous enamel layer.
5. The excess, non-fitted enamel is eliminated by brushing and blowing. The disc has not heated up significantly because it can still be handled barehanded.
6. A layer of primer and a PTFE-based finish layer are then successively applied to each face of the substrate. The application of these PTFE-based non-stick layers can be carried out by silkscreen or by pneumatic spraying (or by roller).
7. The sintering of these non-stick layers is carried out by oven firing at 415° C. for 7 minutes.
8. Finally, the disc thus prepared is stamped to form the shell of a pan conforming to the present invention, whose inner face is that which comprises, under the non-stick coating, a hard enamelled base.

It is observed that the inner coating does not show any visible fissures.

Evaluation of Abrasion Resistance

The abrasion test results show that after 20,000 “round trip” passes of an abrasive pad, the coating shows no scratches extending to the metal.

Evaluation of the Substrate Adhesion of the Fitted (or Sintered) Coating

The adhesion measured with the checkerboard test after immersion is excellent: no squares are torn off.

Evaluation of the Non-Stick Characteristic (So-Called “Burnt Milk” Test)

The non-stick characteristic evaluated by the burnt milk test gives a rating of 50.

### Control Example C2

Starting with an Aqueous Slip of “Steel” Enamel Frit Without an Absorber, and Sintering by Oven Firing at 560° C.

Procedure
1. An aluminium disc 300 mm in diameter is used as a substrate. This disc is degreased, then brushed to obtain a roughness Ra of 1.5 μm.
2. An aqueous enamel slip frit is prepared from F2 “steel” enamel frit using the proportions given below:
100 parts by weight of frit, and
60 parts by weight of water.
3. This slip is then applied to one of the faces of the substrate by pneumatic spraying under 5 bars pressure: the deposit obtained is discontinuous and the dry weight deposited before sintering is 1.2 g.
4. The discontinuous layer is fired in an oven at 560° C. for 8 minutes to harden it.

The firing temperature is insufficient for hardening the hard base, which remains in powder form with no adhesion to the substrate.

On the other hand, firing at a higher temperature, 650° C. in particular, which is a temperature allowing the hardening and sintering of the hard base, leads to fusion and deformation of the substrate.

Comparison of Examples 2 and C2 therefore shows that laser sintering makes it possible to gain access to basic formulations having fusion points higher than those of the substrate.

### Example 3

Starting with an Aqueous Suspension of Alumina with No Absorber and Sintering by the Laser Route

Procedure
1. A square 4917 aluminium plate, each side being 100 mm, is used as a substrate. This plate is degreased, then matt etched.
2. An aqueous dispersion containing 70% by weight of alumina powder is prepared.
3. This aqueous dispersion is then applied to one of the faces of the substrate by pneumatic spraying under 3 bars pressure: the deposit obtained is discontinuous and the dry weight deposited before sintering is 0.7 g.
4. For laser sintering of the enamelled face, a fiber laser operating at a power of 50 W and emitting at a wavelength of 1,064 nm is used: the laser beam scans the entire surface and heats the alumina particles. These particles anchor themselves in the aluminium substrate by local superficial melting of the substrate.
5. A light gray discontinuous coating is obtained with a coverage of 50% and a roughness Ra of between 2 and 5 μm; the thickness of the hard base being between 1 and 5 μm.

Evaluation of Impact Resistance

Immediately after applying the shock to the fitted ceramic layer, observation of the coated face does not show any chipped areas.

An adhesive tape is firmly applied to the impacted part, then pulled off sharply and examined under the optical microscope: the absence of powder on the tape is noted, which reveals excellent adhesion of the hard base to the substrate.

### Example 4

Starting with an Aqueous Suspension of Titanium Dioxide with No Absorber, and Sintering by the Laser Route

Procedure
1. A square 4917 aluminium plate, each side being 100 mm, is used as a substrate. This plate is degreased, then etched.
2. An aqueous dispersion containing 70% by weight of titanium dioxide powder is prepared.
3. This aqueous dispersion is then applied to one of the faces of the substrate by pneumatic spraying under 3 bars pressure: the deposit obtained is discontinuous and the dry weight deposited before sintering is 0.6 g.
4. For laser sintering of the deposited alumina layer, the same fiber laser is used as for Example 3: the laser beam scans the entire surface and heats the titanium dioxide particles. These particles anchor themselves in the aluminium substrate by local superficial melting of the substrate.
5. A black discontinuous coating is obtained with a coverage of 60% and a roughness Ra of between 2 and 5 μm; the thickness of the hard base being between 1 and 5 μm.

Evaluation of Impact Resistance

Immediately after applying the shock to the fritted ceramic layer, observation of the coated face does not show any chipped areas.

An adhesive tape is firmly applied to the impacted part, then pulled off sharply and examined under the optical microscope: the absence of powder on the tape is noted, which reveals excellent adhesion of the hard base to the substrate.

### Example 5

Starting with an Aqueous Suspension of Stainless Steel Powder, with No Absorber, and Sintering by the Laser Route

Procedure
1. A square 4917 aluminium plate, each side being 100 mm, is used as a substrate. This plate is degreased, then matt etched.
2. An aqueous dispersion of stainless steel powder is prepared using the proportions given below:
100 parts by weight of 304 stainless powder of diameter d50<10 μm,
45 parts by weight of demineralised water,
1 part by weight of wetting agent, and
5 parts by weight of an alcohol (typically propanol), to obtain a homogeneous suspension.
3. This aqueous dispersion is then applied to one of the faces of the substrate by pneumatic spraying under 3 bars pressure: the deposit obtained is discontinuous and the dry weight deposited before sintering is 0.4 g.
4. For laser sintering of the deposited alumina layer, the same fiber laser is used as for Examples 3 and 4: the laser beam scans the entire surface and heats the steel particles. These particles anchor themselves in the aluminium substrate by local superficial melting of the substrate.
5. A black discontinuous coating is obtained with a coverage of 30% and a roughness Ra of between 2 and 5 μm; the thickness of the hard base being between 1 and 15 μm.

Evaluation of Impact Resistance

Immediately after applying the shock to the fritted ceramic layer, observation of the coated face does not show any chipped areas.

An adhesive tape is firmly applied to the impacted part, then pulled off sharply and examined under the optical microscope: the absence of powder on the tape is noted, which reveals excellent adhesion of the hard base to the substrate.

### Example 6

Starting with an Oily Aluminium Enamel Frit Paste with an Absorber and Sintering by the Laser Route

Procedure
1. An aluminium disc 300 mm in diameter is used as the substrate. This disc is degreased, then brushed to obtain a roughness Ra of 1.5 μm.
2. An oily enamel fit suspension is prepared from F1 “aluminium” enamel fit using the proportions given below:
100 parts by weight of enamel frit,
120 parts by weight of an oil based on rosin and terpine derivatives,
40 parts by weight of a type D60 petroleum naphtha, and
2 parts by weight of absorber.
3. This dispersion is then applied to one of the faces of the substrate by pneumatic spraying under 3 bars pressure:
due to the oily dispersion's strong tendency to spread, it is not possible to obtain a discontinuous layer,
the composition of the oily dispersion is then modified as follows:
100 parts by weight of enamel frit,
70 parts by weight of oil, and
2 parts by weight of absorber.
The layer is uniformly but discontinuously deposited by silkscreen. To immobilize the drops and prevent them from coalescing, it is necessary to dry the deposited coating with hot air or infrared before laser sintering.
4. For laser sintering of the enamelled deposit, the same fiber laser is used as for Example 1:
the laser beam must be increased and the scan rate reduced, to scan the entire surface and allow sintering of the enamel droplets. During the laser's scan a considerable release of black smoke is observed.
the coating obtained is black and covered with fine carbon dust.
5. A layer of primer and a PTFE-based are applied successively to the enamel layer thus deposited. The application of these PTFE-based non-stick layers can be accomplished by silkscreen or by pneumatic spraying (or by roller).
6. Sintering of these non-stick layers is carried out by oven firing at 415° C. for a duration of the order of 7 minutes.
7. Finally, the disc thus prepared is stamped to form the shell of a pan conforming to the present invention, such that the inner face is that which includes a hard base under the non-stick coating.

This interior coating (inner face) does not show any visible fissures.

Evaluation of the Substrate Adhesion of the Fitted Coating

The adhesion measured by the checkerboard test after immersion is poor: several squares are torn out by virtue of the presence of non-adhering carbon particles resulting from combustion of the oil.

### Example 7

2-Stage Sintering by the Laser Route of a Hard Enamel Base, then of a PTFE-Based Non-Stick Coating

Procedure:
1. An aluminium disc 300 mm in diameter is used as a substrate. This disc is degreased, then brushed to obtain a roughness Ra of 1.5 μm.
2. An aqueous enamel frit slip is prepared from F1 “aluminium” enamel frit using the proportions given below:
100 parts by weight of frit,
60 parts by weight of water,
1 part by weight of absorber.
3. This slip is then applied to one of the faces of the substrate by pneumatic spraying under 5 bars pressure: the deposit obtained is discontinuous and the dry weight deposited before sintering is 1.2 g.
4. For laser sintering of the enamelled deposit, the same fiber laser is used as that of Example 2 (operating at a power level of 4 kW): the laser beam scans the entire surface and frits the enamel droplets to form a discontinuous enamel layer on each face of the substrate.
5. A primer layer and a PTFE-based finish layer are then successively applied to the enamel layer thus formed. The application of these PTFE-based non-stick layers can be carried out by silkscreen or by pneumatic spraying (or by roller).
6. The sintering of these non-stick layers is also accomplished by the laser route: the heating of the underlying hard ceramic layer is sufficient to ensure the sintering of the PTFE coating.
7. Finally, the disc thus prepared is stamped to form the shell of a pan conforming to the present invention, in such a way that the inner face is that which includes a hard base under the non-stick coating.

The interior coating (on the inner face) of the article thus obtained shows no visible fissures.

Evaluation of the Substrate Adhesion of the Fritted Coating

The adhesion measured by the checkerboard test after immersion is excellent: no squares are torn off.

1. An article having a metal substrate comprising two opposed faces and a ceramic or metallic coating covering at least one of the faces of said substrate, said ceramic or metallic coating having a softening point higher than the melting temperature of the substrate and comprising at least one component that absorbs laser radiation at a wavelength of the order of 1 μm, constituting at least 1% of the weight of said coating,
wherein said ceramic or metallic coating is a discontinuous layer having a surface roughness Ra of between 2 μm and 10 μm and a thickness of between 5 and 30 μm.

2. The article according to claim 1, wherein the absorbing component is selected from among the stainless steels, the metal oxides, silicon carbide, tungsten carbide, graphite, mineral pigments and dyes.

3. The article according to claim 1, wherein said ceramic or metallic coating is a discontinuous layer of alumina and/or titanium dioxide.

4. The article according to claim 1, wherein said ceramic or metallic coating is a discontinuous layer of stainless steel.

5. The article according to claim 1, wherein said ceramic or metallic coating is an enamel coating.

6. The article according to claim 5, substrate is made of aluminium or aluminium alloy, and the coating comprises at most 20% by weight of fluxes in relation to the weight of said coating.

7. The article according to claim 5, wherein the substrate is made of stainless steel, and the coating comprises at least 65% by weight of silicon oxide.

8. The article according to claim 1, wherein the thickness of the ceramic or metallic coating is between 5 μm and 15 μm.

9. The article according to claim 1, wherein including a non-stick coating covering said coating, said non-stick coating including at least one layer containing at least one fluorocarbon resin, alone or mixed with a thermally stable bonding resin resisting at least 200° C., this resin forming a continuous fritted lattice.

10. The article according to claim 9, wherein the fluorocarbon resin is selected from among polytetrafluoroethylene (PTFE), tetrafluoroethylene-perfluoropropylvinyl ether (PFE) copolymer, tetrafluoroethylene-hexafluoropropylene (FEP) copolymer and their mixtures.

11. The article according to claim 9, wherein the bonding resin is selected from among the polyamide-imides (PAI), the polyetherimides (PEI), the polyamides (PI), the polyetherketones (PEK), the polyether-etherketones (PEEK), the polyether sulfides (PES) and the polyphenylene sulfides (PPS).

12. The article according to claim 9 wherein the non-stick coating comprises a bonding primer layer and at least one finish layer, at least one of the finish layers defining a surface layer, said primer layers and finish layers comprising, besides the fritted fluorocarbon resin lattice and the bonding resin (if any), mineral or organic fillers and/or pigments.

13. The cookware article according to claim 1, wherein the article occurs in the form of a disc.

14. The article according to claim 1, wherein the article constitutes an article of cookware, one of whose opposite faces is a concave inner face, intended to be put on the side food placed in said article, and a second of said opposite faces is a convex outer face, intended to be set facing a heat source.

15. A manufacturing process for an article, comprising the following steps in succession:
a step of supplying a metal substrate comprising two opposite faces, then
a step of applying a ceramic or metallic composition to at least one of said faces of said substrate to form a non-fritted layer, said ceramic or metallic composition comprising a ceramic or metallic powder and at least one component that absorbs laser radiation at a wavelength of the order of 1 μm, making up at least 1% of the weight of said powder,
a step of sintering by laser beam at a wavelength of the order of 1 □m and irradiating at least partially said discontinuous layer,
wherein
the ceramic or metallic composition is an aqueous dispersion, and
at least one of the applying steps of the aqueous composition or sintering the non-fritted layer is carried out so as to form a discontinuous ceramic or metallic coating.

16. The process according to claim 15, wherein the ceramic or metallic powder is present in the ceramic or metallic composition in the amount of 45% to 75% by weight of the total weight of said composition.

17. The process according to claim 15, wherein the ceramic or metallic composition is applied so as to form a continuous non-fritted layer and the sintering step is carried out by a laser beam irradiating said non-fritted layer in a discontinuous scan.

18. The process according to claim 15, wherein the ceramic or metallic composition is applied so as to form a discontinuous non-fritted layer and the sintering step is carried out by a discontinuous and/or continuous scan of said non-fitted layer.

19. The process according to any one of claim 15, wherein an aqueous enamel frit slip is used as the ceramic or metallic composition.

20. The process according to claim 15, wherein an aqueous suspension of alumina and/or of titanium dioxide is used as the ceramic or metallic composition (3a).

21. The process according to claim 15, wherein an aqueous suspension of stainless steel powder is used as the ceramic or metallic composition.

22. The process according to claim 15, wherein the ceramic or metallic composition is applied to one of the faces of substrate by pneumatic spraying under pressure, and wherein the quantity of ceramic or metallic composition deposited is between 0.1 g/dm² and 3 g/dm².

23. The process according to claim 15, including a step of creating a non-stick coating over said ceramic or metallic coating, comprising depositing at least one layer of fluorocarbon resin-based composition, followed by a sintering step.

24. A process according to claim 23, wherein the non-stick coating sintering step is carried out:
either thermally, by firing in an oven at a temperature between 370° C. and 430° C., or
using a CO₂ laser with a wavelength of 10.6 μm.
